(19) United States
(12) Patent Application Publication
(10) Pub. No.: US 2010/0164945 A1
(43) Pub. Date: Jul. 1, 2010

(54) DIGITAL PHOTO FRAME AND METHOD FOR DISPLAYING PHOTOS IN DIGITAL PHOTO FRAME

(75) Inventor: Qing-Hua Liu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 12/471,655

(22) Filed: May 26, 2009

(30) Foreign Application Priority Data
Dec. 27, 2008 (CN) 200810306577.X

(51) Int. Cl. G06T 1/00

(52) U.S. Cl. 345/418

(57) ABSTRACT

A digital photo frame includes a display control module configured for displaying a two-dimensional first image and a two-dimensional second image having a horizontal parallax with the first image. The display photo frame is capable of displaying the first image at a first angle, and displaying the second image at a second angle. The first image and the second image alternately displayed at a definite interval time produce a three-dimensional appearance based on the first image and the second image.

### BACKGROUND

1. Technical Field

The present disclosure relates to a digital photo frame and a method for displaying photos in the digital photo frame.

2. Description of Related Art

Digital photo frames (DPF) are becoming increasingly popular due to the convenience and ease of manipulation when browsing photos stored therein. However, the typical digital photo frame can only display the photos in a way that is perceived by viewers as two-dimensional.

What is needed, therefore, is a digital photo frame and a method for displaying photos in a way so that they can be perceived as being three-dimensional.

### BRIEF DESCRIPTION OF THE DRAWINGS

FIG. 1 is an exploded schematic diagram of an embodiment of a digital photo frame.

FIG. 2 is an assembled schematic diagram of FIG. 1.

FIG. 3 is a flow chart of an embodiment of a method for displaying photos in the digital photo frame.

### DETAILED DESCRIPTION

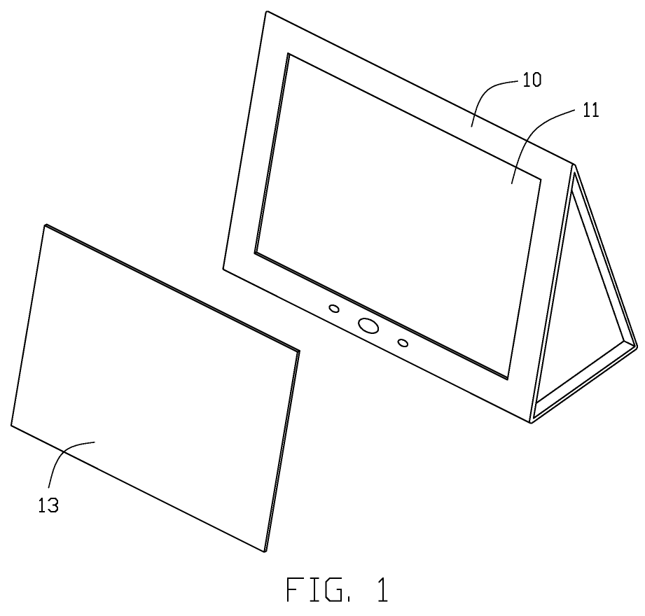

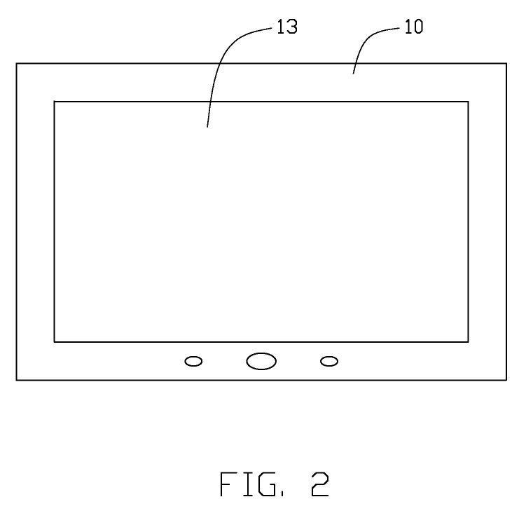

Referring to FIGS. 1 and 2, an embodiment of a digital photo frame 10 includes a screen 11, a display control module stored in the digital photo frame 10 and a raster 13 attached on the screen 11. The raster 13 is substantially the same size as the screen 11.

A two-dimensional (2D) first image of an object and a 2D second image of the same object having a horizontal parallax with the first image are stored in the digital photo frame 10. The two images are shot from two slightly different viewing angles of the same object by a user, to create a deviation similar to that of human binocular vision.

Display positions and display time of the first image and the second image are set before using the digital photo frame 10 for displaying a photo composed of the first image and the second image to be perceived as three-dimensional (3D). The display positions and display timing of the first image and the second image displayed on the screen 11 are predetermined to produce a 3D effect described below. The display control module will control the first image and the second image being continuously alternately displayed on the screen 11, the first image will be directed to a first angle corresponding to one eye of the user through the raster 13, the second image will be directed to a second angle corresponding to the other eye of the user through the raster 13. In this way, the photo is perceived as being 3D by a user.

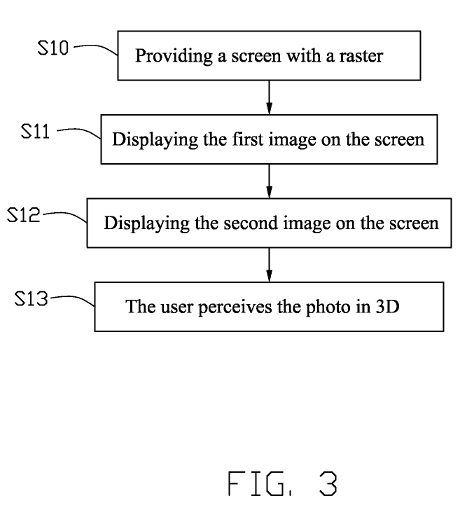

Referring to FIG. 3, a flow chart of a method for displaying photos in the digital photo frame 10 includes the following steps:
S10: Providing a screen 11 with a raster 13;
S11: Displaying the first image of a pair of images of a same subject having slight horizontal parallax on the screen 11 according to the set display position for a preset time, so that the first image will be directed to the first angle corresponding to one eye of the user through the raster 13;
S12: After the preset time for the first image has expired, displaying the second image of the pair image on the screen 11 according to the set display position for the preset time, so that the second image will be directed to the second angle corresponding to the other eye of the user through the raster 13;
S13: Repeating steps 511 and S12, such that the preset time allows the user perceives the photo in 3D.

In another embodiment, rather than a user capturing two 2D images of the same subject, an image processing module is stored in the digital photo frame 10 for processing a single 2D photo stored in the digital photo frame 10 to produce a 2D third image and a 2D fourth image having a horizontal parallax with the third image. The third and forth images will be displayed.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A digital photo frame, comprising:
a display control module configured for displaying a two-dimensional first image and a two-dimensional second image having a horizontal parallax with the first image;
wherein the display photo frame is capable of displaying the first image at a first angle, and displaying the second image at a second angle; the first image and the second image alternately displayed at a definite interval time produce a three-dimensional appearance based on the first image and the second image.

2. The digital photo frame of claim 1, wherein the first and second images are two separate photographs.

3. The digital photo frame of claim 1, further comprising an image processing module stored in the digital photo frame, the image processing module is configured for creating the first and second images from a single photo.

4. A method for displaying photos in a digital photo frame, comprising:
providing a screen of the digital photo frame;
displaying a first image on the screen at a first angle; and
displaying a second image having a horizontal parallax with the first image on the screen at a definite interval time at a second angle.

5. The method of claim 4, wherein the first and second images are two separate photographs.

6. The method of claim 4, wherein an image processing module is stored in the digital photo frame configured for creating the first and second images from a single photo.
